(19) United States
(12) Patent Application Publication
(10) Pub. No.: US 2014/0093231 A1
(43) Pub. Date: Apr. 3, 2014

(54) PROCEDURE, APPARATUS, SYSTEM, AND COMPUTER PROGRAM FOR NETWORK RECOVERY

(71) Applicants: KENNETH MARTIN FISHER, Aurora, IL (US); DAVID W. JENKINS, North Aurora, IL (US); RAMASUBRAMANIAN ANAND, Plainfield, IL (US)

(72) Inventors: KENNETH MARTIN FISHER, Aurora, IL (US); DAVID W. JENKINS, North Aurora, IL (US); RAMASUBRAMANIAN ANAND, Plainfield, IL (US)

(21) Appl. No.: 13/633,652

(22) Filed: Oct. 2, 2012

(51) Int. Cl. H04B 10/00

(52) U.S. Cl. 398/2; 398/1

(57) ABSTRACT

A procedure for recovering a communication network, and a system, apparatus, and computer program that operate in accordance with the procedure. The procedure comprises aggregating network related information. A determination is made, based on the network related information, of whether one or more predetermined failure thresholds have been exceeded, to generate a determining result. The one or more predetermined failure thresholds are based, at least in part, on an aggregation of a predetermined number of failures. A re-provisioning algorithm is executed to re-provision one or more portions of the communication network based on at least one of the network related information and the determining result.

### BACKGROUND

1. Field

Example aspects described herein relate generally to communication networks, and more particularly, to procedures, apparatuses, systems, and computer programs for recovering a network after a network failure.

2. Description of Related Art

In many areas of the world, network failures, such as fiber cuts and/or network element failures, can have a great impact on networks and can often cause decreased network availability for a large portion of a network. Network failures are random in nature and can often involve manual, laborious, time consuming procedures in order to be repaired.

Other approaches to coping with network failures include rerouting traffic in the event of a network failure through the use of the ring-based synchronous optical networking (SONET) multiplexing protocol, the ring-based synchronous digital hierarchy (SDH) multiplexing protocol, and/or an automatically switched optical network (ASON) with an embedded control plane. Both the SONET protocol and the SDH protocol utilize a ring topology in an effort to simplify rerouting in the event of a failure. However, often the network is of a mesh configuration, which can require many potential routes to be selected and provisioned in the event of a failure, making rerouting more complicated. Additionally, although a network protected by conventional SONET/SDH rerouting technology can usually survive a single network failure, i.e., a single fiber failure or a single network element failure, they often cannot survive multiple concurrent failures.

Some ASON networks, in an effort to survive multiple concurrent failures, are configured to utilize an embedded control plane algorithm that relies on existing network elements (e.g., processors of network elements) to handle rerouting in the event of failures. However, this expends valuable processing power of the network elements. Additionally, each network element's capability to detect failures and reroute traffic can be limited by the network element's limited scope of visibility of the network.

In some cases, a network can recover from a minor failure (e.g., a single fiber cut or a single network element failure) by using a pre-defined protection path, such as, e.g., a path defined as part of a SONET/SDH-based and/or an ASON-based protection rerouting scheme. However, the existing SONET/SDH-based and/or ASON-based protection schemes are often insufficient to enable recovery from a large-scale failure (e.g., a catastrophic failure involving multiple fiber failures and/or multiple network element failures).

### SUMMARY

Existing limitations associated with the foregoing, as well as other limitations, can be overcome by a procedure for recovering a communication network after a network failure, and by an apparatus, system, and computer program that operate in accordance with the procedure.

In one example embodiment herein, the procedure comprises aggregating network related information. A determination is made, based on the network related information, of whether one or more predetermined failure thresholds have been exceeded, to generate a determining result. The one or more predetermined failure thresholds are based, at least in part, on an aggregation of a predetermined number of failures. A re-provisioning algorithm is executed to re-provision one or more portions of the communication network based on at least one of the network related information and the determining result.

Further in accordance with an example embodiment herein, the one or more predetermined failure thresholds are further based on at least one of a predetermined network communication loss percentage, a signal alarm loss, and a predetermined amount of time elapsed during an active alarm.

In another example embodiment herein, the network related information is received from at least one of a user interface, a preprogrammed storage device, one or more nodes of the communication network, a recovery server, a management server, an operational support system, and a database.

The procedure can comprise periodically monitoring the network related information from the communication network, according to another example.

Further in accordance with an example embodiment herein, the procedure can comprise determining an extent of one or more failures of the communication network, calculating one or more available routes between a plurality of nodes of the communication network and/or classifying network traffic based on network traffic priority.

In another example embodiment, the procedure comprises identifying high priority traffic that has failed, identifying at least one available path, and re-provisioning the high priority traffic based on the at least one available path. The procedure also can comprise, after re-provisioning the high priority traffic, identifying low priority traffic that has failed, identifying at least one available path, and re-provisioning the low priority traffic based on the at least one available path.

In a further example embodiment, the procedure can comprise determining whether at least one network failure has been resolved, and re-executing the re provisioning algorithm if at least one network failure has been resolved.

The procedure can comprise providing at least one of a notification signal and a logging signal to at least one of a user interface, a recovery server, a management server, an operational support system, and a database, according to another example.

In a further example embodiment, the re-provisioning can be by way of another active communication path besides the primary one(s) that were carrying traffic but failed.

By virtue of the procedure herein, a network is enabled to be more survivable, more available, more flexible, with a greater reporting capability, and better integration with OSS and management systems, and easier upgrades and updates. The example aspects described herein are unlike traditional systems which typically involve very manual laborious and time consuming procedures for recovering after a catastrophic network failure. Additionally, in accordance with example aspects herein, exhaustion of the computation power of network elements can be avoided by using the one or more external computational devices to handle the bulk of the network recovery processing. Moreover, the example embodiments herein enable operations systems (e.g., databases) to be updated with the automated network changes that were made as part of the recovery. In one example embodiment, the procedure herein enables the network to automatically revert to a pre-failure configuration once the failures have been resolved.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, wherein:

FIG. 1 is a representation of an example communication network that is constructed and operated in accordance with at least one example aspect herein.

FIG. 2 is an architecture diagram of a processing system in accordance with an example embodiment described herein.

FIG. 3 is an example flow diagram that illustrates a procedure for recovering a network after a network failure, in accordance with an example embodiment described herein.

FIG. 4 is an example flow diagram that illustrates a procedure for configuring failure thresholds, in accordance with an example embodiment described herein.

FIG. 5 is an example flow diagram that illustrates a procedure for re-provisioning low priority network traffic, in accordance with an example embodiment described herein.

### DETAILED DESCRIPTION

Presented herein is a novel and inventive procedure, and a system, apparatus, and computer program that operate in accordance with the procedure, to recover a network after a failure, such as, by example only, a large-scale failure such as a failure due to a hurricane or another type of natural disaster.

According to one example aspect herein, one or more out of band (external) computational and communication devices are used for network surveillance, network monitoring, network reporting, network optimization, network re-provisioning, and OSS updating. One or more computational devices listen to various information sources, such as, for example, network element (NE) alarms, communications alarms, performance monitoring data, equipment status, and fiber links status. A set of predetermined failure thresholds is programmed into the one or more computational devices that allow the one or more devices to detect network failure(s) and re-provision failed paths based on predetermined rules and/or priorities. After network changes are made, the modification is reported to the appropriate management system, operations support system (OSS) system, and planning system. The one or more computational devices can also be queried by the management system and the OSS system to determine network health statistics.

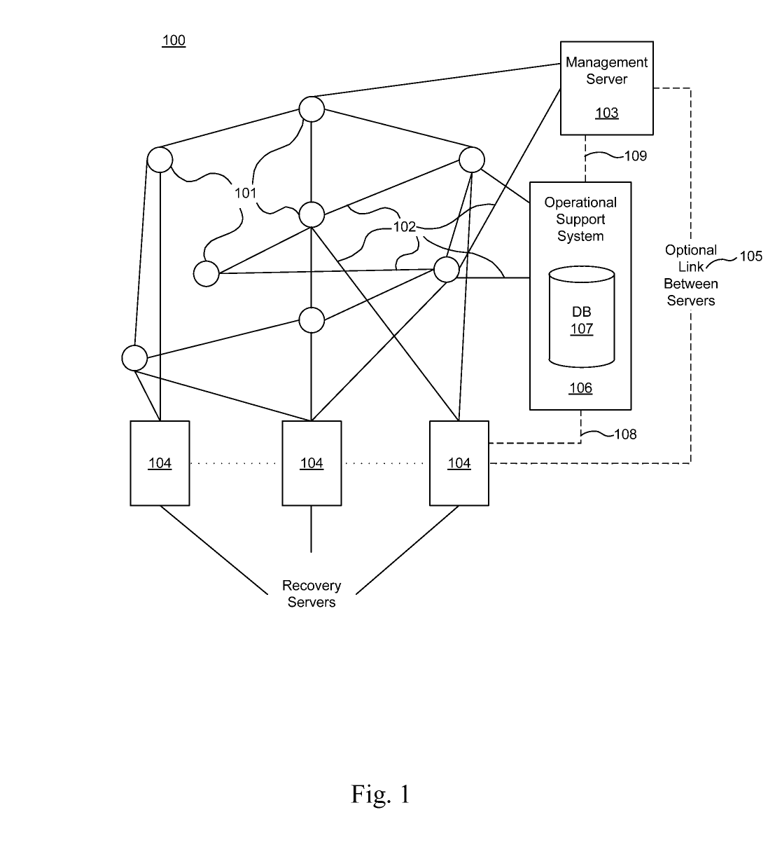

FIG. 1 is a representation of an example communication network 100 that is constructed and operated in accordance with at least one example aspect herein. In one example embodiment, the network 100 represents an optical transport network or a mesh network, although the network 100 can also represent other types of networks, such as, by example only, an IP network, a virtual private network, and/or the like.

The network 100 includes a plurality of nodes 101 (also referred to herein as “network elements”) each representing or including one or more optical signal transmitters, receivers, and/or transceivers configured to transmit and/or receive network traffic signals, such as, by example only, optical signals and/or electrical signals. Although not shown in FIG. 1 for purposes of convenience, each node may also include additional equipment (which can be optical, electrical, and/or opto-electrical), such as, by example only, one or more multiplexers, routers, switches, wavelength selective switches, amplifiers, filters, processors, waveguides, reconfigurable optical add/drop multiplexers (ROADMs), opto-electrical converters, and/or the like. In one example, each node 101 may include one or more transceivers installed in a particular geographical location.

Each of the nodes 101 is communicatively coupled to one or more of the other nodes 101 via a path, which can include one or more links 102. The term “link”, as used herein, refers to a communicative coupling between two adjacent communication devices (e.g., nodes), by which the transceivers of the two devices can transmit and/or receive one or more signals to each other.

Example types of paths include an active path, a protection path, and a restoration path. An active path is a default path (i.e., the paths used in the absence of any associated network failure) by which the particular type of traffic is communicated between the corresponding nodes. A protection path is an alternate path between the nodes which can be quickly switched into (by, e.g., one or more optical and/or electrical switches included at a particular node, not shown in FIG. 1) in the event of a failure of the associated active path. A restoration path is an alternate path between the nodes which can be switched into use, but may require more time to be switched into use than a protection path, in the event of a failure of the associated active path. In one example embodiment, whether a node is capable of supporting a protection path or a restoration path depends on the type of switch(es) (fast switches or slow switches) included in the node. A protection path may be required for important traffic and/or traffic that requires fast switching. For example, for telephone traffic, if an active path experiences a failure, the network should quickly (e.g., in less than 50 milliseconds) switch to an alternate path (i.e., a protection path) because otherwise the telephone call may be dropped. In contrast, for Internet traffic, if an active path experiences a failure, it may be sufficient for the network to switch to an alternate path (i.e., a restoration path) more slowly because there is no risk of dropping a telephone call.

In one example embodiment, each link 102 is constructed of one or more optical fibers able to carry dense wavelength division multiplexed (DWDM) optical signals thereon, but this example should not be construed as limiting. In other example embodiments, each link 102 can represent a wireless communicative coupling or a wired communicative coupling, and the signals communicated through the network 100 can include optical signals, electrical signals, and/or electromagnetic signals.

Also included in the network 100 is a management server 103 that is communicatively coupled to one or more of the nodes 101 of the network 100 via the one or more links 102. The management server 103 is configured to receive one or more signals from, and/or to transmit one or more signals to, each of the nodes 101 via the one or more links 102. In particular, the management server 103 is configured to receive information (e.g., status information, alarm information, node configuration information, link configuration information, traffic demand information, capacity information, alarm location information, network policy information, and/or other types of information) from the nodes 101, and to control the operation of the nodes 101 of the network 100 by transmitting one or more control signals to the nodes 101. In one example embodiment, the management server 103 is configured to receive information from the nodes 101, and to transmit one or more control signals to the nodes 101, by using a predetermined communication protocol (e.g., a command language). In some examples, the management server 103 and one or more recovery servers 104 (described below) are each configured to use a common communication protocol. In another example embodiment, the management server 103 includes a user interface (such as, e.g., the user interface 218 described below) that enables a user to interact with the management server 103 to view the information received from the nodes 101 and/or to control the operation of the nodes 101. In one example, a user can interact with the management server 103 to disable a link 102, register (or de-register) one or more pieces of equipment that have been added to a node 101, modify a network policy, and/or the like.

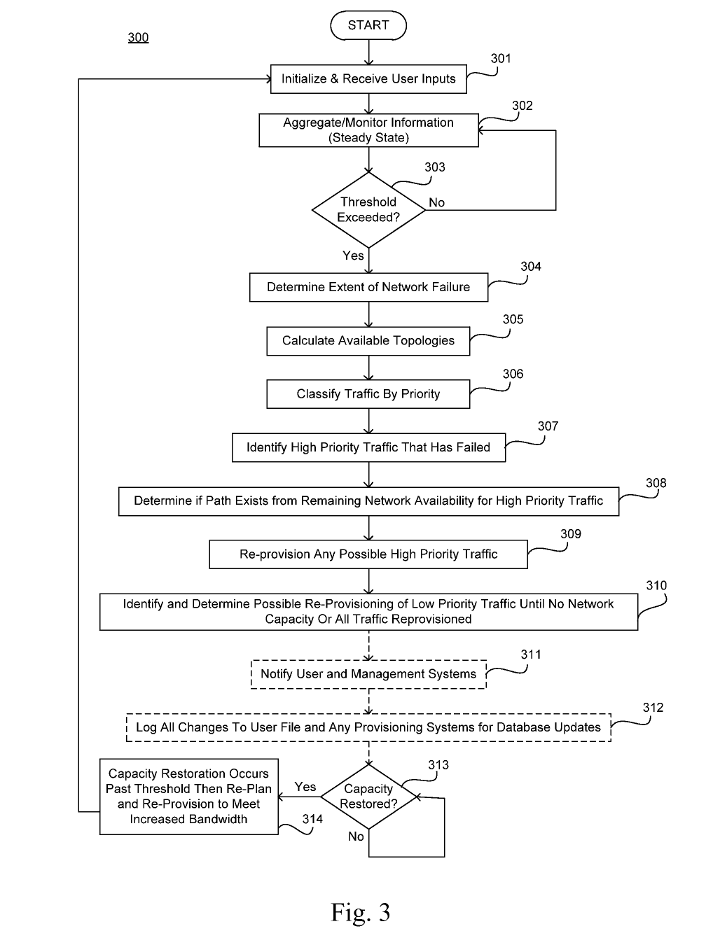

The network 100 also includes one or more recovery servers 104 that are communicatively coupled to one or more of the nodes 101 of the network 100 via the one or more links 102, to detect network failures, and provide instructions for enabling re-routing of traffic through non-failed parts of the network, even in the event of large-scale failures. The recovery servers 104 are configured to receive signals from, and/or to transmit signals to, each of the nodes 101 via the links 102. In particular, as will be described in further detail below in connection with FIG. 3, the recovery servers 104 are configured to receive information (e.g., status information, alarm information, node configuration information, link configuration information, traffic demand information, capacity information, alarm location information, network policy information, and/or other types of information) from the nodes 101, and, in the event of one or more large-scale failures of the components of the network 100, to recover the network 100 by transmitting control signals to the nodes 101. In one example embodiment, the recovery servers 104 are configured to receive information from the nodes 101, and to transmit control signals to the nodes 101, by using a predetermined communication protocol (e.g., a command language). In another example embodiment, the recovery servers 104 include a user interface (such as, e.g., the user interface 218 described below) that enables a user to interact with the recovery servers 104 to view the information received from the nodes 101 and/or to control the operation of the nodes 101.

In another example embodiment, the one or more recovery servers 104 are communicatively coupled to the management server 103 via link 105. In this case, the one or more recovery servers 104 and the management server 103 are configured to receive signals from, and/or to transmit signals (e.g., status information, a log of network recovery information, etc.) to, each other via the one or more links 102, as will be described in further detail below in connection with FIG. 3.

Also included in the network 100 is an operational support system (OSS) 106 that is communicatively coupled to one or more of the nodes 101 of the network 100 via the one or more links 102. In one example embodiment, the operational support system 106 is a server that includes a database 107. The operational support system 106 is communicatively coupled to the one or more recovery servers 104 via link 108, and to the management server 103 via link 109. As will be described in further detail below in connection with FIG. 3, the operational support system 106 is configured to receive information (e.g., status information, alarm information, a log of network recovery information, and/or other types of information) from the nodes 101 via links 102, from the management server 103 via the link 109, and/or from the one or more recovery servers 104 via the link 108. In one example embodiment, the operational support system 106 is owned and operated by a network service provider.

The specific topology of the network 100 of FIG. 1 is provided for illustration purposes only, and should not be construed as limiting. For example, although FIG. 1 shows the management server 103 and specific ones of the recovery servers 104 as being communicatively coupled to specific ones of the nodes 101 via the specific links 102, this is for illustrative purposes only. That is, the management server 103 and/or the one or more recovery servers 104 can include other links and be communicatively coupled to more or less than the number of nodes 101 shown, and/or can be coupled to other ones of the nodes 101. According to some example embodiments, the management server 103, the one or more recovery servers 104, and/or the operational support system 106 are communicatively coupled to all the nodes 101, whether by a single link 102 or by path(s) that includes a plurality of links 102.

Additionally, the particular number of components shown in the network 100 of FIG. 1 is provided for illustration purposes only, and should not be construed as limiting. That is, the network 100 may, in some example embodiments, include one or more of each of the components (e.g., nodes 101, links 102, management server 103, recovery servers 104, operational support system 106, and/or database 107) shown in FIG. 1. In one example embodiment, for redundancy, resiliency, and/or availability purposes, the network 100 can include an interconnected plurality of certain ones of the components (e.g., nodes 101, links 102, management server 103, recovery servers 104, operational support system 105, and/or database 107) shown in FIG. 1.

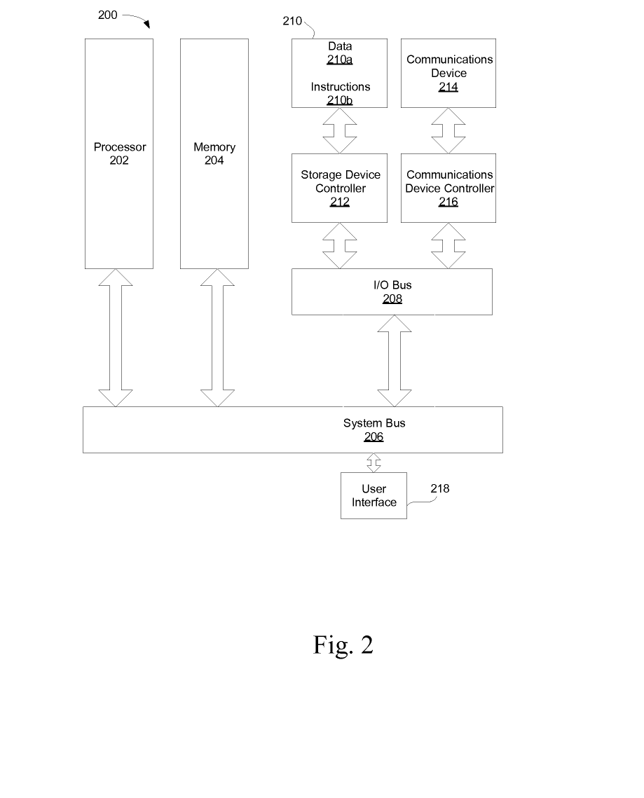

Reference is now made to FIG. 2, which is an architecture diagram of an example data processing system 200, which can be used according to various aspects herein. In one example embodiment, system 200 may further represent, and/or be included in, individual ones of the components of FIG. 1 (e.g., 101, 103, 104, 106). Data processing system 200 can be used to recover a network, such as the network 100 described above, after the network has experienced one or more failures, according to one example. Data processing system 200 includes a processor 202 coupled to a memory 204 via system bus 206. Processor 202 is also coupled to external Input/Output (I/O) devices (not shown) via the system bus 206 and an I/O bus 208, and at least one input/output user interface 218. Processor 202 may be further coupled to a communications device 214 via a communications device controller 216 coupled to the I/O bus 208 and bus 206. Processor 202 uses the communications device 214 to communicate with other elements of a network, such as, for example, network nodes, and the device 214 may have one or more input and output ports. Processor 202 also may include an internal clock (not shown) to keep track of time, periodic time intervals, and the like.

A storage device 210 having a computer-readable medium is coupled to the processor 202 via a storage device controller 212 and the I/O bus 208 and the system bus 206. The storage device 210 is used by the processor 202 and controller 212 to store and read/write data 210a, as well as computer program instructions 210b used to implement the procedure(s) described herein and shown in the accompanying drawing(s) herein (and, in one example, to implement the functions represented in FIG. 3). The storage device 210 also can be used by the processor 202 and the controller 212 to store other types of data, such as, by example only, a topology of a network (i.e., an arrangement of the various components (e.g., nodes, links) of a network), a geographical location of each node, a geographical location of each link, a length of each link, a statistical availability of each link and/or node (i.e., a statistically determined numerical probability that a particular link and/or node will be functional at any given point), a type of optical fiber used for each link, an optical signal to noise ratio of each link and/or node, one or more other optical characteristics of each link and/or node, an optical loss of each link and/or node, a polarization mode dispersion number of each link and/or node, a chromatic dispersion number of each link and/or node, one or more types of components included as part of a node, one or more routing capabilities (e.g., fast switching or slow switching) of each node, network alarm information, network traffic priority information, predetermined protection and/or restoration path information, one or more predetermined failure thresholds for triggering recovery of the network, (e.g., an alarm count, an alarm type, an event criteria (such as a performance criteria), a delay timer, etc.), one or more alarms and/or events, and/or any other information relating to each link, node, or any other network component (see description of blocks 301 and/or 302 below), and/or the like. In operation, processor 202 loads the program instructions 210b from the storage device 210 into the memory 204. Processor 202 then executes the loaded program instructions 210b to perform any of the example procedure(s) described herein, for operating the system 200.

Having described data processing system 200, an example aspect herein will now be described. In accordance with this example aspect, multiple recovery servers placed in various locations throughout a network monitor network related information to detect network failures, reroute network traffic to avoid the failures, and communicate with one another, where deemed appropriate to accomplish one or more of those functions. Each of the recovery servers can be in communication with a certain portion of the network (e.g., certain network elements and links), and this portion of the network is deemed “visible” to that particular recovery server. Each of the recovery servers can detect network failures based on network related information received from network elements, links, and/or other network components visible to that recovery server. Unlike traditional systems, which often employ a single network manager with limited network visibility to detect failures, the example aspects described herein can employ recovery servers placed in various locations throughout the network to collectively provide substantially network-wide visibility for monitoring for failures, provisioning recovery routes, and the like. In other words, visibility throughout the network is thereby maximized or substantially increased relative to traditional systems. By virtue of having such greater visibility of the network, the recovery servers can aggregate failure conditions and address them individually, altogether, or otherwise, and on a large scale, even for catastrophic failures spanning across a large part of the network that would not otherwise be visible to only one server. Also, by addressing failures altogether in aggregate, more optimal traffic recovery routes can be provisioned than may be possible if failures were addressed on an individual basis using traditional systems on a single server.

A network recovery procedure 300 in accordance with one example aspect herein will now be described with reference to FIG. 3. FIG. 3 is an exemplary flow diagram that illustrates a network recovery procedure 300 that may be used in accordance with an example embodiment herein. In one example embodiment, the process of FIG. 3 may be performed by each individual one of the recovery servers, although for convenience the procedure is described from the perspective of a single server 104.

At block 301, the recovery server 104 is initialized by receiving various types of information relating to the network (e.g., network 100) being monitored and/or recovered. The information received by the recovery server 104 at block 301, as well as the various types of information that can be received by the recovery server 104 at each of blocks 302 through 314 (described below), may be received via, for example, the user interface 218 (e.g., inputted by a user), the storage device 210 (which may be preprogrammed to provide the various information to the recovery server 104), and/or one or more external devices (e.g., nodes 101, other servers 104, or other network components) by way of a network (e.g., links 102) and the communications device 214.

Example types of information that may be received by the recovery server 104 at block 301 include, without limitation, a topology of a network (i.e., an arrangement of the various components (e.g., nodes, links) of a network), a geographical location of each node, a geographical location of each link, a length of each link, a statistical availability of each link and/or node (i.e., a statistically determined numerical probability that a particular link and/or node will be functional at any given point), a type of optical fiber used for each link, an optical signal to noise ratio of each link and/or node, one or more other optical characteristics of each link and/or node, an optical loss of each link and/or node, a polarization mode dispersion number of each link and/or node, a chromatic dispersion number of each link and/or node, one or more types of components included as part of a node, one or more routing capabilities (e.g., fast switching or slow switching) of each node, network alarm information, failure indications, network traffic priority information, predetermined protection and/or restoration path information, one or more predetermined failure thresholds for triggering recovery of the network, (e.g., an alarm count, an alarm type, an event criteria (such as a performance criteria), a delay timer, etc.), and/or any other information relating to each link, node, or any other network component.

In one example embodiment, information that may be provided (at block 301) to recovery server 104 by a user via user interface (e.g., user interface 218), if it is so provided, may include an instruction configuring one or more predetermined failure thresholds, an instruction configuring one or more network recovery algorithms, an instruction configuring one or more network traffic prioritizations, an instruction configuring one or more predefined protection and/or restoration paths, an instruction configuring one or more predetermined restoration levels (e.g., an instruction regarding whether network recovery is to proceed (1) to satisfy the maximum possible number of traffic demands, i.e., without considering protection and/or restoration paths, or (2) to satisfy a number of traffic demands that is possible while maintaining the use of protection and/or restoration paths), and/or the like.

Once the recovery server 104 has been initialized by receiving (block 301) various types of information relating to the network, the recovery server 104 begins to monitor and/or aggregate information (e.g., one or more inputs), at block 302, in order to detect, and help the network recover from, a large-scale network failure, as will be described in further detail below in connection with block 303. The information monitored and/or aggregated by the recovery server 104 at block 302 may be received from the nodes 101, the management server 103, the operational support system 106, other recovery servers 104, and/or other network components. In one example embodiment, multiple recovery servers 104 share network related information with each other via the links 102. In this way, each recovery server 104 can obtain as much information about the network (e.g., failures, availability, rerouting capabilities of network elements, etc.) as possible, to be utilized in achieving an optimal re-provisioning of traffic in the event of a large-scale failure. Additionally, if a particular portion of a network is not visible to one of the recovery servers 104, that recovery server 104 may obtain information relating to the non-visible portion of the network 104 from one or more other ones of the recovery servers 104, which have that portion of the network within their visibility.

The recovery server 104 can monitor and/or aggregate various types of inputs, such as, by example only, one or more alarms and/or events, and can monitor whether the recovery server 104 is able to communicate with (transmit a signal to and/or receive a signal from) one or more of the other network components (e.g., nodes 101, the management server 103, the operational support system 106, and/or other recovery servers 104).

One type of information the recovery server 104 can receive and/or aggregate at block 301 and/or 302 is network traffic priority information. In particular, recovery server 104 may receive, from nodes 101, the management server 103, the operational support system 106, and/or other network components, network traffic priority information that includes a predetermined priority level for each type of network traffic. In one example, the predetermined priority level for each type of network traffic is determined based on network service tiers defined in a service level agreement(s) of network service provider(s).

Another type of information the recovery server 104 can receive and/or aggregate at block 301 and/or 302 is network traffic protection information. In particular, recovery server 104 may receive, from nodes 101, the management server 103, and/or the operational support system 106, network traffic protection information that includes a predetermined protection scheme for each type of network traffic (e.g., a number of active paths, protection paths, and/or restoration paths for the type of traffic, a bandwidth amount for each type of traffic for each path, etc.).

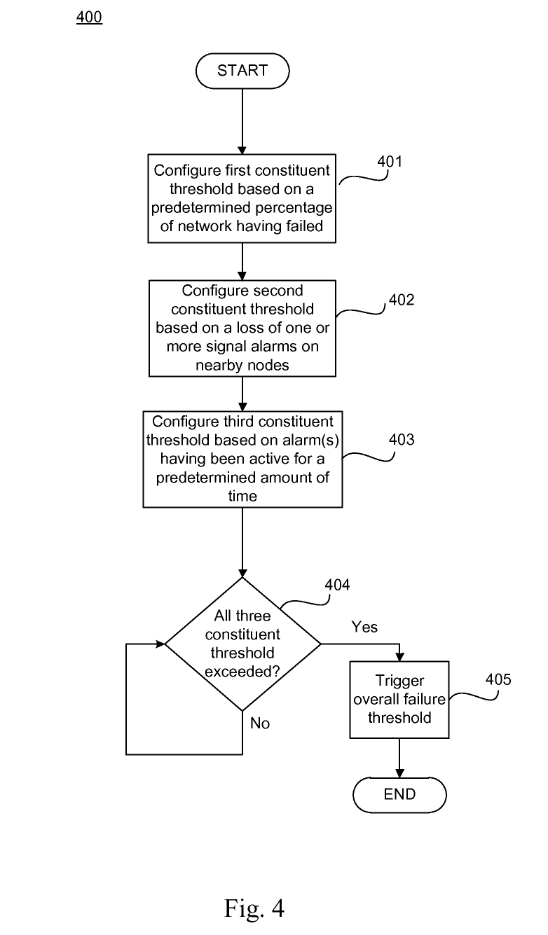

At block 303, the recovery server 104 determines, based on the inputs received at block 301 and/or the inputs received and/or aggregated at block 302, whether one or more predetermined failure thresholds have been exceeded. The one or more predetermined failure thresholds can be configured by a user via a user interface (e.g., user interface 218) as part of block 301 (described above) for example for being used to identify whether a failure of a predetermined proportion has occurred. In one example embodiment, the recovery server 104 uses a single predetermined failure threshold to determine whether a failure has occurred. In another example embodiment, the recovery server 104 collectively uses a combination of a plurality of failure thresholds to determine whether a failure has occurred. For example, and referring to procedure 400 of FIG. 4, which represents in detail this example embodiment of block 303, one overall failure threshold can be configured to include a first constituent failure threshold defined (block 401) as a predetermined percentage of the network (e.g., 33% of the nodes of the network) with which an ability to communicate with has been lost, a second constituent failure threshold defined (block 402) as a loss of one or more signal alarms on one or more nodes located nearby the other nodes with which communication has been lost, and a third constituent failure threshold defined (block 403) as a predetermined amount of time (e.g., thirty minutes) during which the one or more alarms has been active. In this way, the overall failure threshold will be deemed exceeded (triggered) (block 405) only if all three of its constituent failure thresholds have been exceeded (as determined at block 404).

In one example embodiment, the predetermined failure threshold is configured to be triggered only after a predetermined number of failures has been detected and aggregated, at block 302, from one or more sources (e.g., network element(s)). This is unlike traditional systems, which typically attempt to recover from each failure as soon as it becomes detected; i.e., without aggregate multiple failures before attempting recovery. Recovery server 104 is thus enabled to re-provision (block 309 and/or block 310) traffic more efficiently. For example, by waiting until multiple failures (or failures of a specific type) have been detected before attempting recovery, rather than simply rerouting traffic from a failed link to a backup link, recovery server 104 can better allocate available links for various types of traffic, e.g., by matching up types of traffic with links of sufficient bandwidth. In contrast, a traditional system may reroute traffic from a failed link onto a predetermined protection link, without regard for whether, in view of the need to reroute traffic from other additional failed link(s), it would result in an efficient use of bandwidth.

If the recovery server 104 determines at block 303 that the one or more predetermined failure thresholds have not been exceeded, then control is passed back to block 302 where the recovery server 104 continues to monitor one or more inputs.

On the other hand, if the recovery server 104 determines at block 303 that the one or more predetermined failure thresholds have been exceeded, then control is passed to block 304. At block 304, the recovery server 104 determines the extent of the network failure. In one example, the recovery server 104 retrieves as much information (e.g., status information) as possible from as many components of the network as possible (e.g., the nodes 101, links 102, management server 103, other recovery servers 104, operational support system 106, and/or database 107 shown in FIG. 1) to identify the portion of the network that needs to be recovered and the portion (if any) of the network that remains functional and available.

At block 305, the recovery server 104 calculates available topologies, or routes, from each endpoint (e.g., node) to each other endpoint of the network. In addition to the availability of the routes, the recovery server 104 determines at block 305 an amount of bandwidth available for each available route. As will be described in more detail in connection with the example embodiments below, the recovery server 104 uses the topology availability in re-provisioning network traffic.

At block 306, the recovery server 104 classifies network traffic by priority. In particular, the recovery server 104 categorizes traffic based on traffic priority information received at block 301 and 302 (described above).

At block 307, the recovery server 104 identifies high priority traffic that is currently failed. In particular, the recovery server 104 determines which of the traffic that has been classified as high priority traffic at block 306 has also been deemed to have failed at block 304.

At block 308, the recovery server 104 determines if a path exists from remaining network availability for high priority traffic. In particular, the recovery server 104 uses one or more predetermined routing algorithms to calculate one or more paths (if any exist among the paths that have been determined at block 305 to be available) for the high priority traffic to be communicated between two or more endpoints (e.g., nodes). In one example embodiment, the recovery server 104 determines, at block 308, whether any predetermined protection and/or restoration paths are available for high priority traffic. In another example, the recovery server 104 determines, based on configuration input received at block 301 and/or 302, whether the re-provisioning algorithm has permission to route high priority traffic without implementing corresponding protection and/or restoration paths for the traffic.

At block 309, the recovery server 104 re-provisions as much high priority traffic as possible. In particular, the recovery server 104 re-provisions (re-routes) the high priority traffic using the paths determined at block 308 to be available. In one example embodiment, the recovery server 104 re-provisions the high priority traffic until no additional paths are available and/or no additional bandwidth is available.

Although not shown in FIG. 3 for purposes of convenience, in one example embodiment, the recovery server 104 can re-provision (i.e., re-route) high-priority and/or low-priority traffic using specific paths that are selected by a user via a user interface (e.g., user interface 218), for example, as a precautionary measure and/or to achieve a desired network traffic flow.

In another example embodiment, in order to permit a higher amount of traffic to be transmitted throughout the network, the recovery server 104 can re-provision traffic while temporarily disregarding predetermined protection scheme(s) for various types of traffic. For example, instead of re-provisioning a certain type of traffic to have both an active path and a protection path (as its predetermined protection scheme may demand), the recovery server 104 may transmit that traffic over an active link without utilizing a protection path, to enable the protection path to be used for another type of traffic. In this way, in the event of a large-scale network failure, the recovery server 104 may enable a higher amount of traffic to be transmitted throughout the network than would be possible if the predetermined protection scheme(s) were implemented.

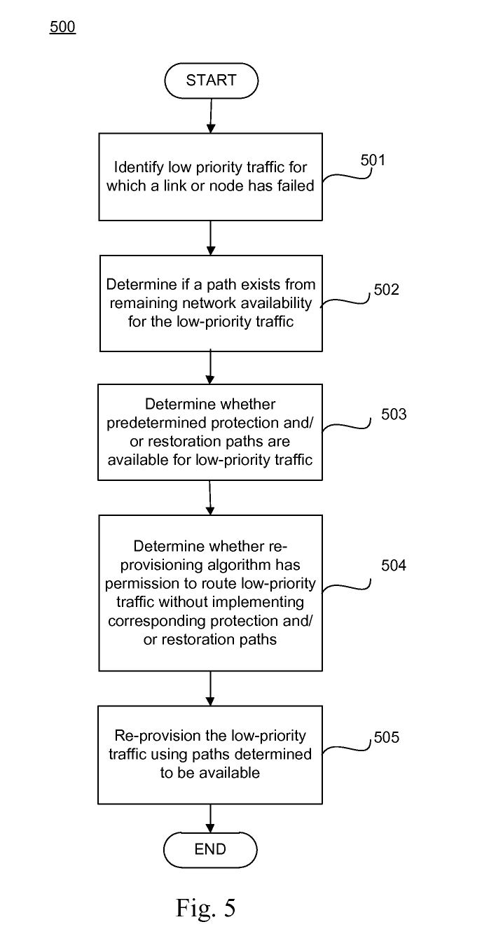

At block 310, the recovery server 104 re-provisions low priority traffic to the extent possible. In one example embodiment, at block 310 the recovery server 104 repeats the procedures of blocks 307, 308, and 309 described above, but instead of high priority traffic, the processor focuses on low priority traffic. Before continuing to describe the procedure 300 of FIG. 3, reference will be made to the procedure 500 of FIG. 5, which represents in detail an example embodiment of block 310. In particular, the recovery server 104 first identifies (block 501) low priority traffic for which a link or node is currently failed. That is, the recovery server 104 determines which of the traffic that has been classified as low priority traffic at block 306 corresponds to a link or node that has also been deemed to have failed at block 304. The recovery server 104 then determines (block 502) if a path exists from remaining network availability for the low priority traffic. In particular, the recovery server 104 uses one or more predetermined routing algorithms to calculate one or more paths (if any exist among the paths that have been determined at block 305 to be available) for the low priority traffic to be communicated between two or more endpoints (e.g., nodes). In one example embodiment, the recovery server 104 determines (block 503) whether any predetermined protection and/or restoration paths are available for low priority traffic. In another example, the recovery server 104 determines (block 504), based on configuration input received at block 301 and/or block 302, whether the re-provisioning algorithm has permission to route low priority traffic without implementing corresponding protection and/or restoration paths for the traffic.

The recovery server 104 then re-provisions (block 310) as much low priority traffic as possible. In particular, the recovery server 104 re-provisions (block 505) (re-routes) the low priority traffic using the paths determined at block 308 to be available, taking into account the utilization of the paths by the high priority traffic re-provisioned at block 309. In one example embodiment, the recovery server 104 re-provisions the low priority traffic until no additional paths are available and/or no additional bandwidth is available. Although not shown in FIG. 5 for purposes of convenience, in other example embodiments the procedure 500 may include less than all of the procedures associated with blocks 501 through 505 (described above), and may include, for example, a subset of those blocks 501 through 505.

In some example embodiments, the procedure 300 can further include one or more of the functions associated with optional blocks 311 and/or 312. At optional block 311, the recovery server 104 provides one or more notification signals via a user interface (e.g., a user interface 218 of the management server 103). The notification signals may include information regarding the state of the network, the progress of the recovery, any re-provisioning results, and/or any other relevant information.

At optional block 312, the recovery server 104 provides one or more logging signals to be stored in one or more databases (e.g., for possible off-line and/or historical analysis). In one example embodiment, the one or more logging signals are provided by recovery server 104 to a database (e.g., database 107 of operational support system 106) via a communication path (e.g., path 108). The one or more logging signals may include, for example, information regarding the state of the network, the progress of the recovery, any re-provisioning results, a log of all actions that occurred before, during and/or after detection of a failure, and/or any other relevant information. In this way, if desired, once all of the previously detected (block 303) failures have subsided, the configuration of the network can be reverted to its pre-failure configuration to maintain optimal performance. Additionally, the log can be analyzed to determine the cause of the one or more failures in an effort to come up with ways to prevent those failures from occurring in the future.

At block 313, the recovery server 104 determines whether any network capacity (e.g., availability of paths, etc.) has been restored. In one example embodiment, the recovery server 104 determines, based on an updated retrieval of inputs (e.g., the inputs previously received at block 301 and/or block 302), whether one or more predetermined failure thresholds that were previously exceeded are no longer exceeded.

If the recovery server 104 determines at block 313 that no network capacity (or insufficient network capacity) has been restored, then, in one example embodiment, the recovery server 104 continues to monitor, at block 313, various types of information relating to the network to detect when network capacity has been restored. In one example, the recovery server 104 monitors various types of information relating to the network by periodically retrieving (e.g., at a predetermined repetition rate) one or more inputs from one or more sources, such as, for example, the inputs previously received at block 301 and/or block 302 (described above) (these inputs may be received, e.g., periodically or otherwise).

On the other hand, if the recovery server 104 determines at block 313 that at least some network capacity has been restored, then the recovery server 104 re-provisions (block 314) the high priority traffic and/or the low priority traffic, utilizing the increased availability provided by the restored capacity (e.g., in accordance with the procedures described above in connection with one or more of blocks 304 through 312). In this way, the network can be incrementally (partially or fully) recovered over time as failed portions of the network recover, so as to take maximum advantage of the availability of the network at any given time. That is, traffic can be restored as applicable parts of the network recover, or, depending on predetermined operating criteria, only after the network is fully recovered.

The example aspects herein provide a procedure, as well as an apparatus, system, and computer program that operate in accordance with the procedure, that provide monitoring and recovery measures for a communication network after one or more network failures. By virtue of the procedure herein, a network is enabled to be more survivable, more available, more flexible, with a greater reporting capability, better integration with operational support system(s) and management server(s), and with easier upgrades and updates. The example aspects described herein are unlike traditional systems which typically involve very manual, laborious, and time consuming recovery procedures after a large-scale network failure. Additionally, in accordance with example aspects herein, exhaustion of the computation power of network elements can be avoided by using one or more external recovery servers to handle network recovery processing. Moreover, the example embodiments herein enable operational support systems (e.g., databases) to be updated with the automated network changes that were made as part of the recovery. In one example embodiment, the procedure herein enables the network to automatically revert to a pre-failure configuration once the failures have been resolved.

It should be noted that the above functions need not all be performed by individual servers 104. For example, the servers may collaborate such that certain one(s) of them perform certain ones of the blocks, while certain other one(s) of them perform other ones of the blocks, and such servers inter-communicate to enable the procedure to be performed as a whole. Also, the re-provisioning of traffic through non-failed parts of the network may include, for example, one or more servers 104 communicating with other server(s) 104 to determine whether those other server(s) 104 have visibility to parts of the network which are not visible to the servers 104, and then collaborating with those other server(s) 104 to re-provision and route traffic through those parts of the network, assuming they are in working order. Moreover, the procedure may be performed such that each of plural servers 104 performs it with respect to the part of the network within its visibility, resulting in those servers 104 collectively providing network-wide monitoring and failure detection and recovery procedures, in the manner described above.

The devices and/or servers described herein may be, in one non-limiting example, a computer or farm of computers that facilitate the transmission, storage, and reception of information and other data between different points. From a hardware standpoint, in one example a server computer will typically include one or more components, such as one or more microprocessors (also referred to as “controllers”) (not shown), for performing the arithmetic and/or logical operations required for program execution. Also in one example, a server computer will also typically include disk storage media (also referred to as a “memory”), such as one or more disk drives for program and data storage, and a random access memory, for temporary data and program instruction storage. From a software standpoint, in one example a server computer also contains server software resident on the disk storage media, which, when executed, directs the server computer in performing its data transmission and reception functions. As is well known in the art, server computers are offered by a variety of hardware vendors, can run different operating systems, and can contain different types of server software, each type devoted to a different function, such as handling and managing data from a particular source, or transforming data from one format into another format.

In the foregoing description, example aspects of the invention are described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of example aspects described herein may be provided as a computer program product, or software, that may include an article of manufacture on a machine-accessible, computer-readable, and/or machine-readable medium (memory) having instructions. The instructions on the machine-accessible, computer-readable and/or machine-readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium”, “computer-readable medium”, “machine-readable medium”, or “memory” used herein shall include any medium that is capable of storing, encoding, or transmitting a sequence of instructions for execution by the machine and that cause the machine to perform any one of the procedures described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs. Indeed, the numbered parts of the above-identified procedures represented in the drawings may be representative of operations performed by one or more respective modules, wherein each module may include software, hardware, or a combination thereof.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures.

Although example aspects herein have been described in certain specific example embodiments, many additional modifications and variations would be apparent to those skilled in the art. It is therefore to be understood that the various example embodiments herein may be practiced otherwise than as specifically described. Thus, the present example embodiments, again, should be considered in all respects as illustrative and not restrictive.

What is claimed is:

1. A procedure for recovering a communication network, the procedure comprising:
aggregating network related information;
determining, based on the network related information, whether one or more predetermined failure thresholds have been exceeded, to generate a determining result, the one or more predetermined failure thresholds being based, at least in part, on an aggregation of a predetermined number of failures; and
executing a re-provisioning algorithm to re-provision one or more portions of the communication network based on at least one of the network related information and the determining result.

2. The procedure of claim 1, wherein the one or more predetermined failure thresholds are further based on at least one of a predetermined network communication loss percentage, a signal alarm loss, and a predetermined amount of time elapsed during an active alarm.

3. The procedure of claim 1, wherein the aggregating network related information further comprises receiving the network related information from at least one of a user interface, a preprogrammed storage device, one or more nodes of the communication network, a recovery server, a management server, an operational support system, and a database.

4. The procedure of claim 1, further comprising periodically monitoring the network related information from the communication network.

5. The procedure of claim 1, further comprising determining an extent of one or more failures of the communication network.

6. The procedure of claim 1, further comprising calculating one or more available routes between a plurality of nodes of the communication network.

7. The procedure of claim 1, further comprising classifying network traffic based on network traffic priority.

8. The procedure of claim 1, further comprising:
identifying high priority traffic that has failed;
identifying at least one available path; and
re-provisioning the high priority traffic based on the at least one available path.

9. The procedure of claim 8, further comprising, after re-provisioning the high priority traffic:
identifying low priority traffic that has failed;
identifying at least one available path; and
re-provisioning the low priority traffic based on the at least one available path.

10. The procedure of claim 1, wherein the network related information comprises at least one of a topology of the communication network, a geographical location of a node, a geographical location of a link, a length of a link, a statistical availability of a link, a statistical availability of a node, a type of optical fiber used for a link, an optical signal to noise ratio of a link, an optical signal to noise ratio of a node, an optical loss of a link, and an optical loss of a node.

11. The procedure of claim 1, wherein the network related information comprises at least one of a polarization mode dispersion number of a link, a polarization mode dispersion number of a node, a chromatic dispersion number of a link, a chromatic dispersion number of a node, node component information, node routing capability information, network alarm information, network traffic priority information, predetermined protection path information, predetermined restoration path information, predetermined failure threshold information, and network traffic priority information.

12. The procedure of claim 1, further comprising:
determining whether at least one network failure has been resolved; and
re-executing the re-provisioning algorithm if at least one network failure has been resolved.

13. The procedure of claim 1, further comprising providing at least one of a notification signal and a logging signal to at least one of a user interface, a recovery server, a management server, an operational support system, and a database.

14. The procedure of claim 1, wherein a plurality of recovery servers inter-communicate to perform at least one of the aggregating, the determining, and the executing.

15. The procedure of claim 1, wherein the executing re-provisions network traffic by way of at least one non-protection communication path.

16. A system for recovering a communication network, the system comprising:
at least one apparatus arranged to:
aggregate network related information;
determine, based on the network related information, whether one or more predetermined failure thresholds have been exceeded, to generate a determining result, the one or more predetermined failure thresholds being based, at least in part, on an aggregation of a predetermined number of failures; and
execute a re-provisioning algorithm to re-provision one or more portions of the communication network based on at least one of the network related information and the determining result.

17. The system of claim 16, the at least one apparatus being further arranged to determine an extent of one or more failures of the communication network.

18. The system of claim 16, the at least one apparatus being further arranged to calculate one or more available routes between a plurality of nodes of the communication network.

19. The system of claim 16, the at least one apparatus being further arranged to classify network traffic based on network traffic priority.

20. The system of claim 16, the at least one apparatus being further arranged to:
identify high priority traffic that has failed;
identify at least one available path; and
re-provision the high priority traffic based on the at least one available path.

21. The system of claim 20, the at least one apparatus being further arranged to, after re-provisioning the high priority traffic:
identifying low priority traffic that has failed;
identifying at least one available path; and
re-provisioning the low priority traffic based on the at least one available path.

22. An apparatus comprising:
at least one communication interface, arranged to aggregate network related information; and
at least one processor coupled to the at least one communication interface, and arranged to:
determine, based on the network related information, whether one or more predetermined failure thresholds have been exceeded, to generate a determining result, the one or more predetermined failure thresholds being based, at least in part, on an aggregation of a predetermined number of failures, and
execute a re-provisioning algorithm to re-provision one or more portions of the communication network based on at least one of the network related information and the determining result.

23. The apparatus of claim 22, wherein the at least one processor is further arranged to determine an extent of one or more failures of the communication network and calculate one or more available routes between a plurality of nodes of the communication network.

24. The apparatus of claim 22, wherein the at least one processor is further arranged to classify network traffic based on network traffic priority.

25. The apparatus of claim 22, the at least one apparatus being further arranged to:
identify high priority traffic that has failed;
identify at least one available path; and
re-provision the high priority traffic based on the at least one available path.

26. The apparatus of claim 25, the at least one apparatus being further arranged to, after re-provisioning the high priority traffic:
identify low priority traffic that has failed;
identify at least one available path;
and re-provision the low priority traffic based on the at least one available path.
